(19) United States
(12) Patent Application Publication
(10) Pub. No.: US 2008/0193248 A1
(43) Pub. Date: Aug. 14, 2008

(54) Load Lashing Device

(75) Inventor: Lennart Lindblad, Vargarda (SE)

Correspondence Address: ALFRED J MANGELS, 4729 CORNELL ROAD, CINCINNATI, OH, 452412433, US

(73) Assignee: QUALIS AB, ASKIM (SE)

(21) Appl. No.: 11/886,284

(22) PCT Filed: Mar. 14, 2006
(86) PCT No.: PCT/SE2006/000321

§ 371 Date: Sep. 13, 2007

(30) Foreign Application Priority Data
Mar. 14, 2005 (SE) 0500578-0

(51) Int. Cl. B60P 7/00

(52) U.S. Cl. 410/100

(57) ABSTRACT

A goods lashing device to enable control of the tension in a load lashing strap or other flexible lashing. A number of thin, bent, arched plates that have spring properties are connected with the lashing strap for tightening of the lashing strap. The plates have spaced openings at their ends and attachment axles are arranged in pairs at a mutual distance from each other and pass through the plate openings to receive the ends of the plates. Singly, or in a packet of several bent plates, the plates are assembled onto the attachment axles with the ends of a single plate or of a packet of plates held at a mutual distance from each other, as viewed along the axial extension of each attachment axle. The plates are arranged to straighten from their original bent position when the lashing strap is tightened with the required load holding force

### BACKGROUND OF THE INVENTION

1. Field of the Invention

The present invention relates to a goods lashing device to enable control of tightening of a load. A mechanism is provided including a number of thin and bent plates that exhibit spring properties are joined with a lashing strap for tightening the lashing strap or other flexible load lashing system. The plates are arranged to straighten during tightening of the lashing strap with required tensile force.

2. Description of the Related Art

Under the transport of specific types of goods that are lashed with the help of a strap, chain, wire, or other lashing, the applied tightening force on the lashing strap often drops on account of the lashed goods becoming more compact and thus forming a smaller volume through, for example, vibration or heavy seas.

Previously disclosed through, among others, DE 19527065 C2 is an automatic strap adjuster. In that connection a rubber band produces the tensioning of the strap. However, no large tightening force can be accomplished using a rubber band, which must be continuously tensioned with greater tightening of the strap.

Furthermore, previously disclosed through U.S. Pat. No. 6,357,978 B1 is a load meter, where a spring section that interacts with an axle in an eye is arranged in order to indicate the load effect. However, that load meter does not permit easy reading of the load indicator's compaction.

The device disclosed through U.S. Pat. No. 5,026,230 A includes a compactable spring (119) arranged between two pieces of metal joined to a strap. That device forms an adjustment device and primarily an indicator.

DE 9406818 U1 shows a force indicator for straps that is formed from a U- or V-shaped spring section (4) and two strap linkage parts (2, 3), which are preferably enclosed in a common plastic material. When the strap (1) is tensioned the parts stretch out. With that the markings (6) can indicate when the strap tension (1) is good or bad.

U.S. Pat. No. 4,247,235 A and US 2003/0174055 A1 show a tensioning device and indicating devices for strap lashing. However, no specific indication is given of how the tightening of the strap is checked.

The principal object of the present invention is thus, with basic and cost effective means, to provide a device that partly checks that sufficient tightening force is applied to a lashing strap, partly with a subsequent check during transport to clearly see whether the tightening force has been reduced, and as a result to be able to perform additional tightening in time.

### SUMMARY OF THE INVENTION

The above-mentioned object is achieved by a device in accordance with the present invention, which essentially includes pairs of attachment axles situated at a mutual distance from each other. The axles are arranged to receive the ends of thin, bent plates. Single bent plates or packets with several bent plates are connected to the attachment axles, with the ends of the single plates or packets of plates held at a mutual distance from each other, seen along each attachment axle's axial extension.

### BRIEF DESCRIPTION OF THE DRAWINGS

The invention is described below through a number of accounted operative examples, in which reference is made to the enclosed drawings in which,

FIG. 1 shows a perspective view of an embodiment of a tension indicator in accordance with the present invention,

FIG. 2 shows in an exploded view the component parts of the tension indicator shown in FIG. 1,

FIG. 3 shows a spring plate,

FIG. 4 shows the tension indicator according to FIG. 1 with lashing strap sewn on,

FIG. 5 shows how the spring plates, in the tension indicator according to FIG. 4, straighten out when the lashing strap is tensioned in the direction of the arrows,

FIG. 5A shows how the spring plates, according to FIG. 4, have completely straightened out at full load on the lashing strap,

FIG. 6 shows the tension indicator in accordance with FIGS. 1 and 4 with straight reinforcement ends,

FIG. 7 shows a reinforcement end in accordance with FIG. 6 with elongated holes,

FIG. 8 shows an alternative, reversed, application of the spring plates in accordance with FIG. 3,

FIG. 9 shows the tension indicator in accordance with FIG. 8 with the anchor in an attachment eye,

FIG. 10 shows an alternative implementation of the tension indicator in accordance with FIG. 8,

FIG. 10A shows a load take-up in perspective,

FIG. 11 shows an alternative embodiment of the tension indicator in accordance with FIG. 6, with an alternative form of bend in the spring plates,

FIG. 12 shows the spring plates and reinforcement ends respectively, in accordance with FIG. 11 in perspective,

FIG. 13 shows the tension indicator in accordance with FIG. 1 directly mounted in a so-called strap winch for tightening of the lashing strap,

FIG. 14 shows a tension indicator—strap winch—combination,

FIG. 15 shows a tension indicator—strap winch—combination, in accordance with FIG. 14, equipped with a middle section,

FIG. 16 shows the device in accordance with FIG. 15 with the strap tensioned,

FIG. 17 shows the device in accordance with FIG. 15 equipped with automatic tightening of the lashing strap,

FIG. 18 shows the device in accordance with FIG. 17 with a tensioned strap, and

FIG. 19 shows a similar device in accordance with FIG. 18, with a self-braking and load take-up gear for tightening and taking up of the load on the lashing strap.

### DESCRIPTION OF THE PREFERRED EMBODIMENTS

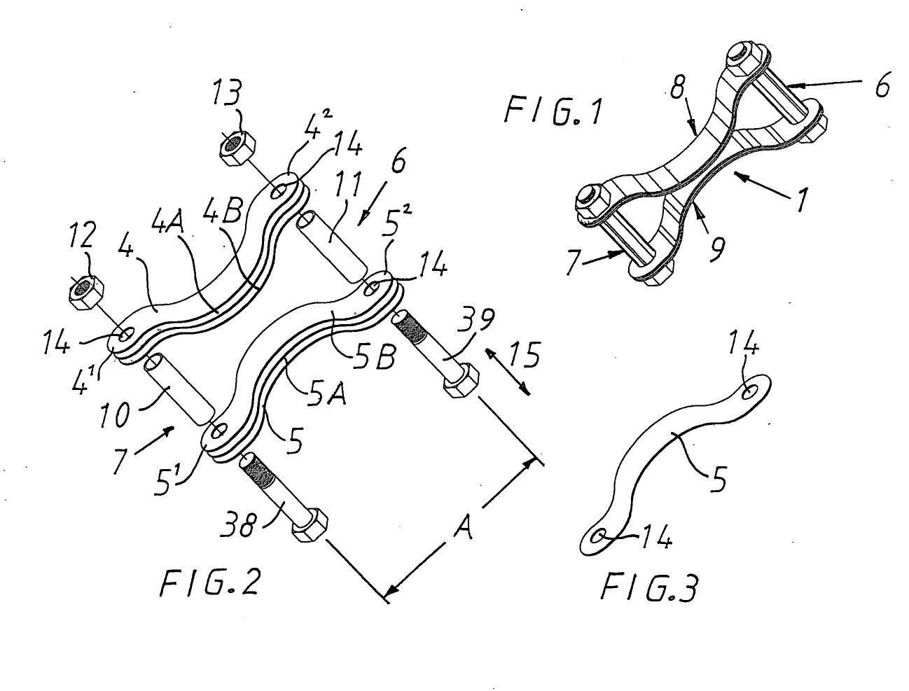

FIGS. 1 through 5A show an embodiment of a tension indicator 1 in accordance with the present invention. The visual inspection of the tightening force required when, for example, lashing goods with a lashing strap 2 of fabric or with another flexible lashing material is enabled with the help of a device in the form of tension indicator 1. The tension indicator is formed by a number of thin, elongated, and curved plates 4, 4A, 4B; 5, 5A, 5B which are arched and have spring properties. The arched or curved plates 4-5B are joined to the lashing strap 2 via appropriate fastenings 6, 7 and are so arranged as to straighten out upon tightening of the lashing strap 2 with the required tensile force F.

The plates 4-5B are a number of thin and heavily bent or arched, elongated plates having spring-back properties. The elongated plates include coplanar outer longitudinal ends and an intermediate arched region and are interconnected with appropriate strap fastenings 6, 7, which are attached, such as by sewing, for example, in an appropriate position on the lashing strap 2. The spring plates 4-5B straighten out when the lashing strap 2 is tightened.

The number of plates can vary from a single arched plate up to a joint packet 8, 9 formed of several separate arched plates. The plates 4-5B are made of metal or plastic, preferably of spring steel, with holes 14 at the respective longitudinal ends 4¹, 4², 5¹, 5² of the plates. The fastenings 6, 7 are formed by bolts that define attachment axles, 38, 39 that are arranged in parallel pairs at a mutual distance from each other and include suitable tubular sleeves 10, 11. The bolts include locking screw-on nuts 12, 13 to lock everything in position, as shown in FIG. 1.

Single bent plates 4, 5 or packets composed of several bent plates 4, 4A, 4B; and 5, 5A, 5B are carried by the attachment axles 38, 39, with the ends 4¹, 4²; 5¹, 5² of single plates or packets of plates held at a mutual distance A from each other, as seen along each attachment axle's axial extension 15. In that connection, at least one end 2A, 2B of a lashing strap 2 is looped over an attachment axle 8, 9 and is sewn with thread 16 onto the associated lashing strap 2.

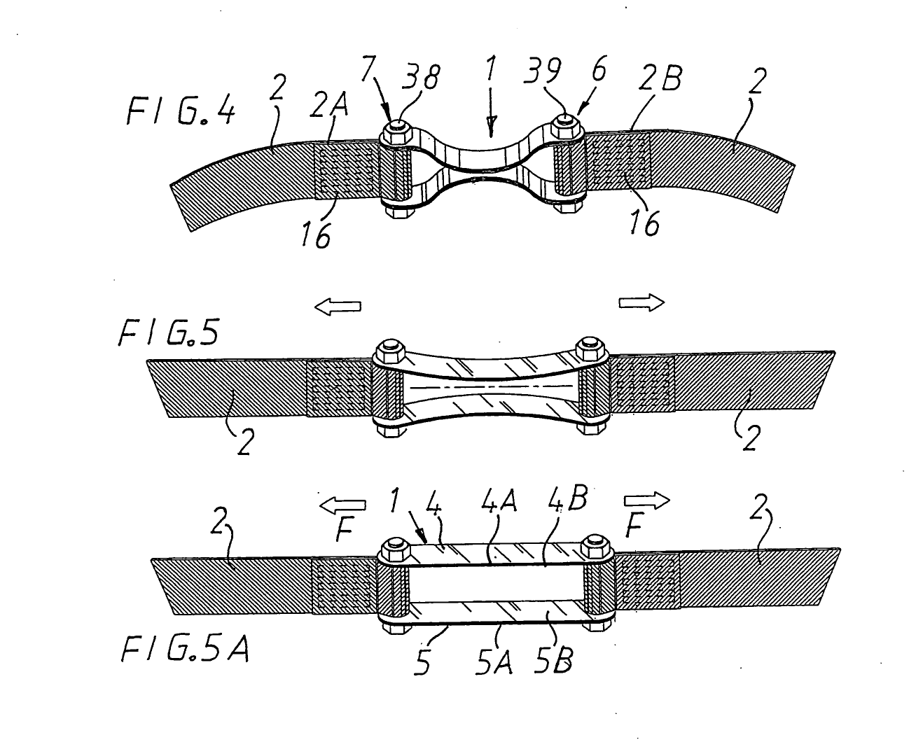

FIG. 5 shows how the spring plates 4-5B in the tension indicator tend to straighten out from their normal curved or arched position when in an unloaded state, as shown in FIG. 4, with the tightening of lashing strap 2 in the directions of the arrows. FIG. 5A shows how the spring plates 4-5B according to FIG. 4 completely straighten out with a full load F on the lashing strap 2. Accordingly, one can easily visually assess whether the strap 2 is tightened with the correct force F by observing the degree of curvature of the plates.

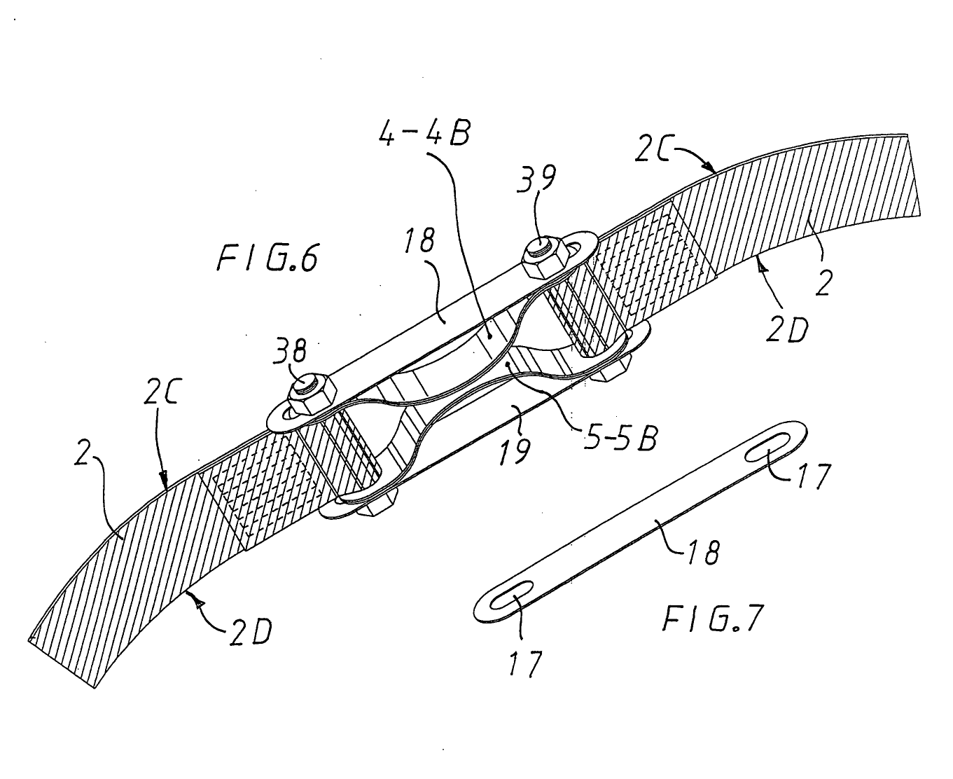

Referring to FIGS. 6 and 7, a side reinforcement member 18, which is interconnectable with the above-mentioned transverse attachment axles 38, 39, includes slotted or elongated openings 17 adjacent each longitudinal end. Reinforcement member 18 is arranged on at least one side edge 2C, 2D of the strap 2 to enable the take-up of a greater load than what the load indicating spring plates 4-5B are calculated to achieve. FIG. 6 shows how both long sides 2C, 2D of strap 2 support similarly formed side reinforcement members 18, 19.

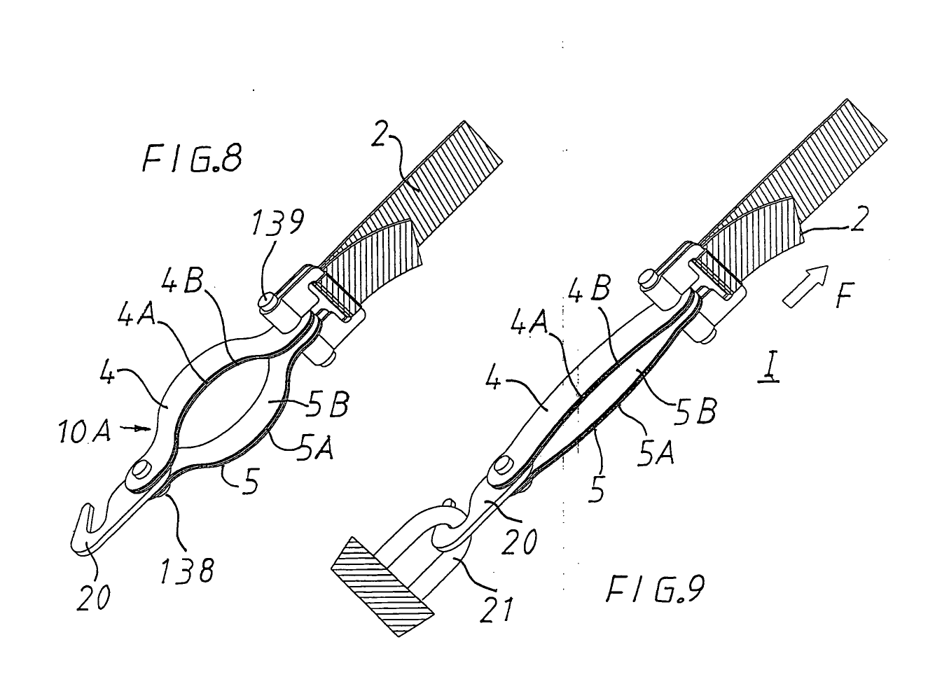

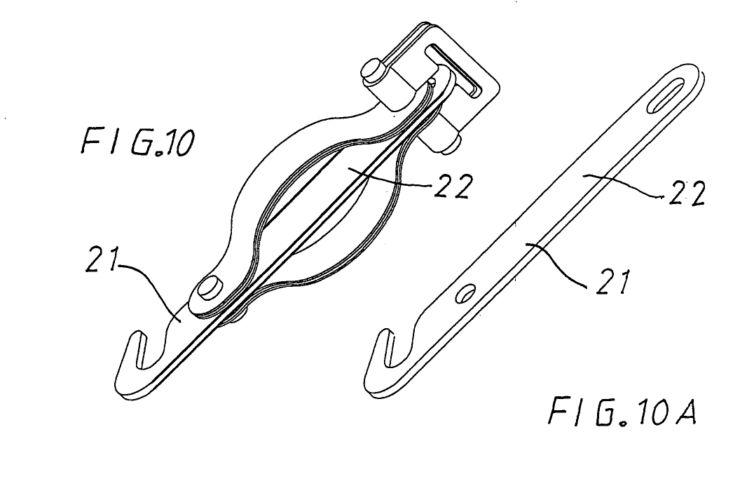

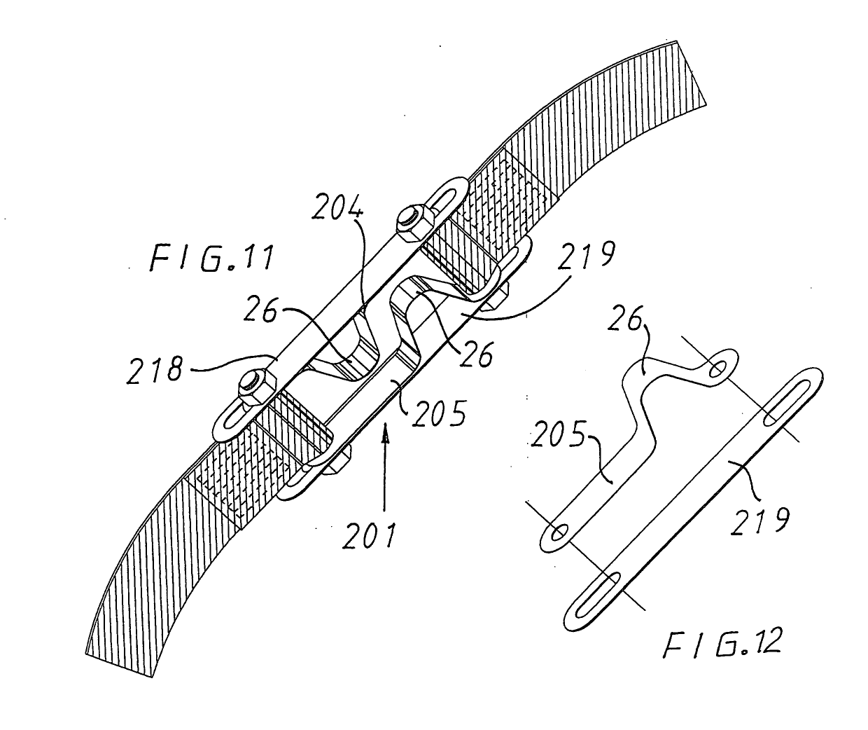

FIG. 8 shows an alternative, reversed curvature direction application of the spring plates 4-5B that form tension indicator 10A. Also shown is an alternative application of the lashing strap 2 by additional tightening and with an equipped anchorage hook 20 that is joined with one of the attachment axles 138, 139. FIG. 9 shows how the hook 20 is received in an attachment eye 21 and that the spring plates 4-4B; 5-5B are held in an extended, straightened position I after tightening of the strap 2 with the required force F. As shown in FIGS. 10 and 10A, a modified form of hook 21 can even form a combined hook and reinforcement member.

Tension indicator 201 shown in FIGS. 11-12 is designed with a bend or curvature 26 that is offset in a longitudinal direction from the center 26 of the spring plates 204, 205 for achieving a longer spring plate extension. Side reinforcement members 218, 219 can also be provided.

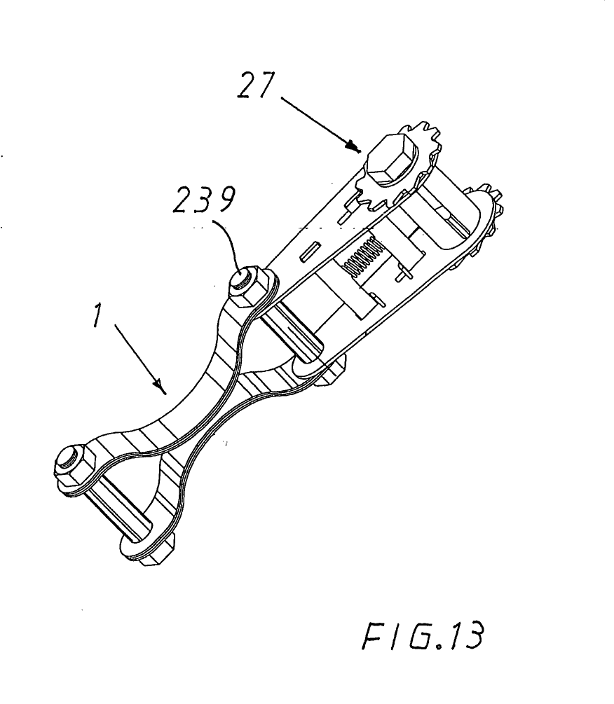

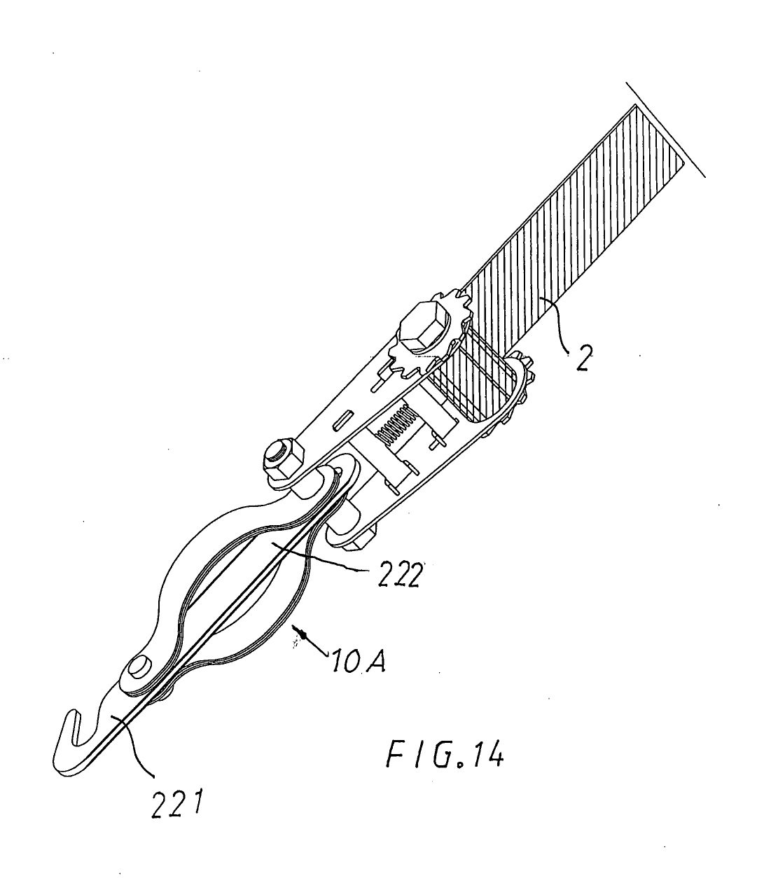

A manual strap winch 27, as shown in FIG. 13, or a motorized strap winch 28, as shown in FIG. 17, can be connected with a strap 2 and with an attachment axle 239 arranged between them. FIG. 13 shows the tension indicator 1 directly mounted to a strap winch 27 for tightening the lashing strap 2, while in FIG. 14 the tension indicator 10A is equipped with a hook 221 with an extension forming a reinforcement member 222.

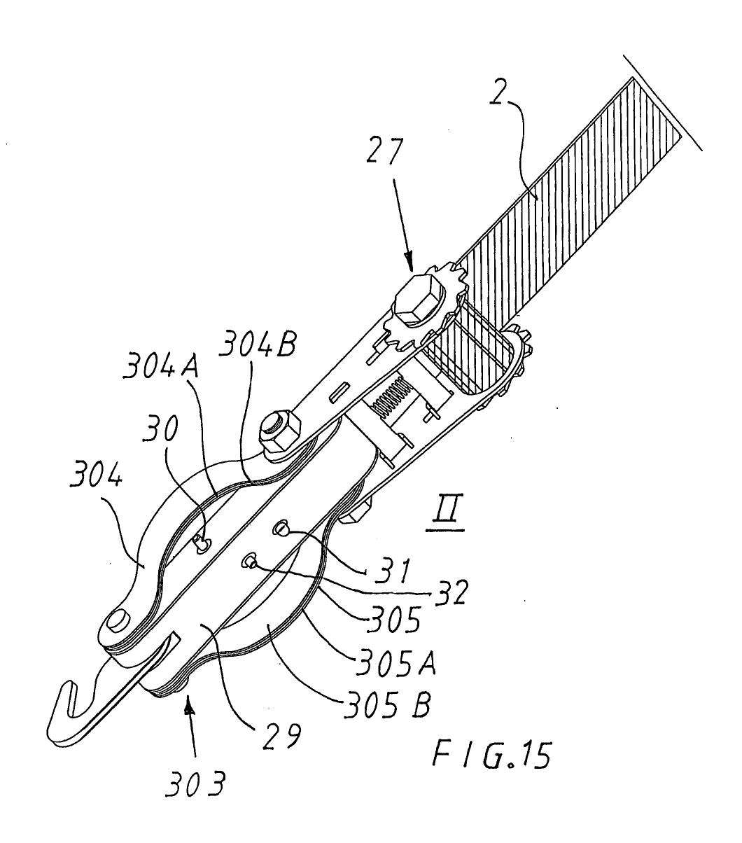

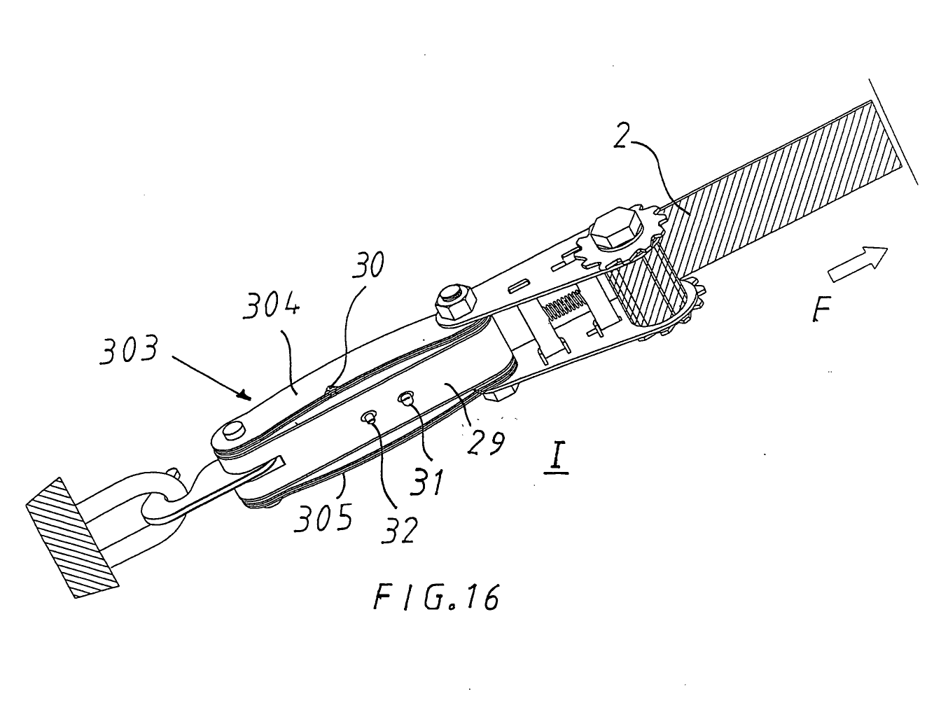

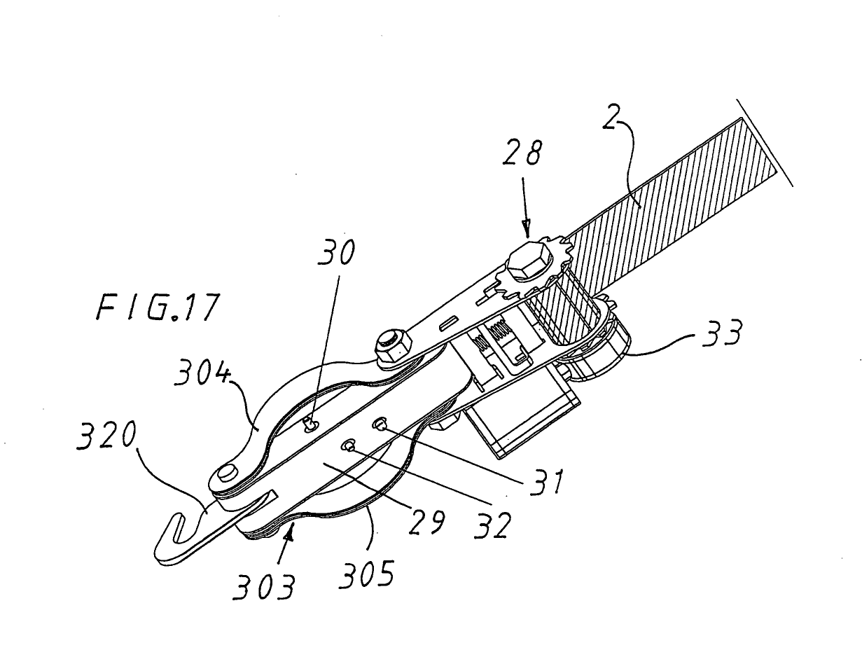

FIGS. 15-19 show examples of a tension indicator 303 combined with an electrically controllable middle section 29 including, among others, a battery (not shown), an electrical connector (not shown), and a light emitting diode 31 or a signal sender for remote transfer of information to the user, for example to the dashboard in the cab of a truck. A signal can be provided by a displaying controllable middle section 29 having an indicator 31 that is mounted between the packet of plates 304, 304A, 304B; and the packet of plates 305, 305A, 305B which are shown in FIG. 15 in an unextended or unstraightened position. A pushable actuation button 30 is placed relative to a plate packet so that it can be pressed into an operative position by a plate packet when the plate packets forming tension indicator 303 are in the loaded, extended position shown in FIG. 16. When the load on the strap 2 is reduced for some reason, it is an object of the invention that the slack condition of the strap 2 is indicated to the vehicle driver without the need of his having to climb up onto the load and trying all the lashing straps 2. A signal is displayed to the driver that there is a problem in the shape of tension indicator 303. A simple means of indication can be arranged in the driver's cab, for example a lamp. The lamp lights when the plate packets 304-305B are in the unextended, curved position II, as shown in FIG. 15, so that the actuation button 30 is released from its depressed condition. With the help of an additional button 32 the function can be reset.

The above-described middle section 29 can thus contain a wireless signal transmitter (not shown), and a receiver that includes an indication means can also be arranged at a suitable distance to display an indication of the plate packet positions I and II, as shown in FIGS. 16 and 15, respectively.

In FIG. 17 the device is shown with the plate packets in the position shown in FIG. 15, and equipped with, for example, a gear motor 33 in order to achieve automatic tightening of the lashing strap 2 when a signal is transmitted to the motor from the middle section 29 of tension indicator 303. Gear motor 33 is positioned between a hook 320 and the strap 2.

Tightening of strap 2 is also arranged to enable continuous operations, whereby sensors can be arranged that detect the tightening force on the strap, and which stop tightening at a defined tension value.

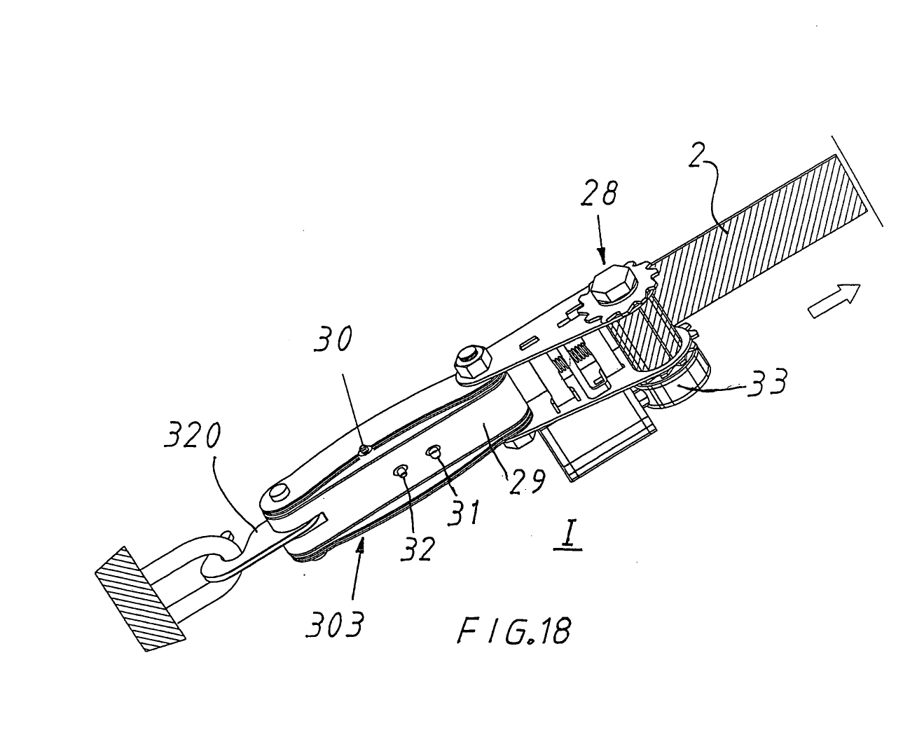

FIG. 18 shows how the middle positioned tension indicator 303, with the lashing strap 2 under tension and the plate packets in a straightened position I, achieves depression of the actuation button 30.

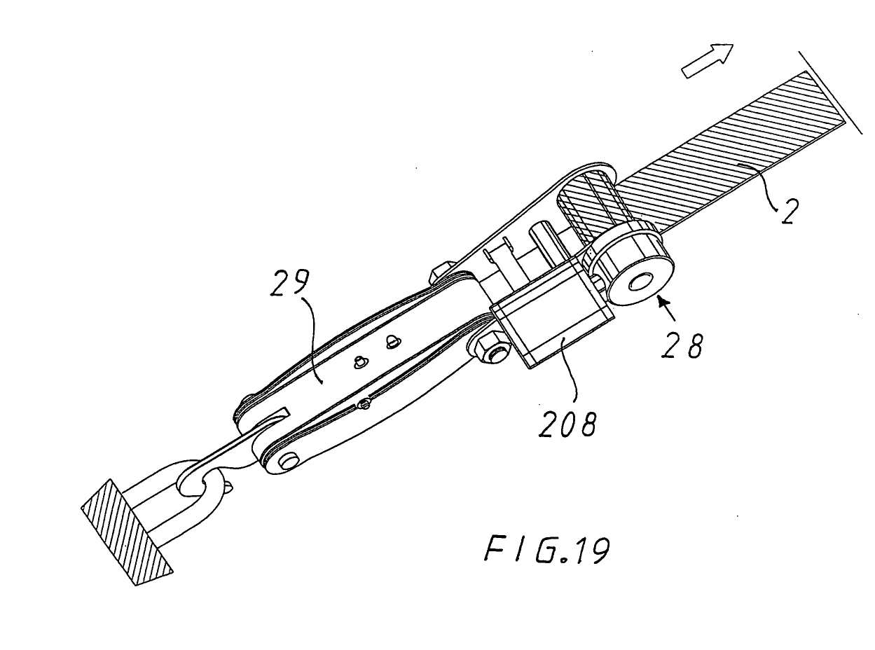

FIG. 19 shows a similar device as that in FIG. 18, but with a self-braking and load take-up gear 208 on a motor 28 to achieve tightening and load take-up on the lashing strap 2.

The function of the invention has probably been understood from the above description and the embodiments shown in the drawings. However, the invention is naturally not limited to the above description and to the embodiments shown in the enclosed drawings. Modifications are possible, especially with regard to the character of the different parts, or through the use of equivalent technology, without deviating from the restricted area for the invention, such as is defined in the appended claims.

What is claimed is:

1. A load lashing device to enable an indication of the tightness of lashing used to hold a load in position, said lashing device comprising: a pair of opposed, elongated plates having coplanar ends that include respective opposed end openings and an intermediate arched region between the end openings, wherein when placed under tension the plates elongate longitudinally as a result of deflection of the arched region toward a longitudinal centerline of the plates; a pair of spaced, parallel attachment axles situated at mutual distance from each other to extend through the openings at the ends of the plates, wherein at least one of the attachment axles passes through a loop formed at an end of a lashing strap; and wherein when the lashing strap is placed under tension a deflection of the plates of the lashing device toward a straightened condition provides an indication of the tightness of the lashing.

2. A load lashing device in accordance with claim 1, wherein the plates are each formed of a packet including a plurality of individual, equally formed plates.

3. A load lashing device in accordance with claim 1, wherein the plates are formed of plastic.

4. A load lashing device in accordance with claim 1, wherein the plates are formed of spring steel.

5. A load lashing device in accordance with claim 1, wherein at least one end of the lashing strap is connected to an attachment axle by a sewn connection.

6. A load lashing device in accordance with claim 1, including a slotted side reinforcement member that is connected with and extends between the attachment axles along at least one side edge of the lashing strap.

7. A load lashing device in accordance with claim 1, including a hook connected to at least one attachment axle.

8. A load lashing device in accordance with claim 1, including a strap winch connected with a lashing strap and extending between an attachment axle and around the lashing strap.

9. A load lashing device in accordance with claim 8, wherein the strap winch is a motorized winch for automatic strap tightening.

10. A load lashing device in accordance with claim 1, including a controllable middle section positioned between a pair of plate packets each having a plurality of plates and is actuated by deflection of the plate packets to provide a visual indication by means of a lamp when the plate packets are spaced from an actuator button provided on the middle section.

11. A load lashing device in accordance with claim 10, wherein the middle section includes a signal transmitter for wirelessly transmitting a signal indicative of positions of the plate packets, and a receiver spaced from the transmitter that includes display means to permit an indication of the plate packet positions relative to the actuator button.
